(19) United States
(12) Patent Application Publication
(10) Pub. No.: US 2010/0057559 A1
(43) Pub. Date: Mar. 4, 2010

(54) METHOD OF CHOOSING ADVERTISEMENTS TO BE SHOWN TO A SEARCH ENGINE USER

(76) Inventors: Saar Wilf, Tel Aviv (IL); Nir Rostoker, Kiryat Bialik (IL); Oz Solomon, Thornhill (IL); Erich S. Finkelstein, Kirkland, WA (US)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/817,227

(22) PCT Filed: Jul. 2, 2007
(86) PCT No.: PCT/US2007/072620

§ 371 Date: Aug. 28, 2007

Related U.S. Application Data
(60) Provisional application No. 60/817,451, filed on Jun. 30, 2006.

(51) Int. Cl. G06Q 30/00; G06F 17/30

(52) U.S. Cl. 705/14.49; 707/706; 707/E17.108

(57) ABSTRACT

A system and method for finding relevant advertisements to a search engine user's query where said query is received by a search engine, returning one or more search results by the search engine and analyzing the search results to determine more precisely or more broadly the search engine user's objective or interest and using the analysis to determine which advertisements, stored in an advertisement database, to present to the search engine user.

### CROSS REFERENCE TO RELATED APPLICATIONS

The present invention claims priority from U.S. Provisional Patent Application No. 60/817,451 dated Jun. 30, 2006, which is incorporated herein in its entirety and PCT/US2007/72620 filed Jul. 2, 2007.

### FIELD OF THE INVENTION

The present invention relates to a method for determining relevant advertisements to show to a search engine user (“User”) who has issued a search query against a search engine.

### BACKGROUND OF THE INVENTION

A search engine allows end-users to search for items within a data repository. Typically, a search engine user will provide to the search engine one or more search words (“Search Words”), and the search engine will show a list of pages that contain those words (“Search Results”), which may optionally contain an excerpt from each page (“Page Excerpt”) which may optionally show the Search Words in their context. One of the most common forms of a search engine is an Internet Search Engine (ISE), which maintains a list of words appearing in pages available over the Internet. Such search engines are well known in the art.

Search engines will often show a list of advertisements matching the Search Words. This is usually achieved by having the advertiser provide a list of words (“Keywords”), which, if matched by the Search Words, will cause the advertisement to appear. For example, an advertiser may choose the Keywords ‘volleyball’ and ‘shoes’, which will cause his advertisement to appear if the search engine user issues a query such as ‘best volleyball shoes for women’. This current method is limited in that the search engine user's objective may not always be easily predicted from his or her Search Words alone. Because of this, the search engine user may not be able to find a relevant advertiser to meet their needs and, similarly, the search engine may lose potential business in not presenting relevant advertisements that the search engine user might otherwise have clicked on. This current method also suffers because the process of generating all the possible Keywords by the advertiser can be cumbersome and incomplete, and, further, could result in outdated keyword lists.

### OBJECT AND SUMMARY OF INVENTION

The object of the invention is to provide more relevant advertisements to a search engine user and further to allow advertisements placed by advertisers to more easily be matched against a wider range of Search Words, without requiring advertisers to invest a substantial amount of effort in manually creating more Keywords. This object is achieved by providing a system and method for utilizing the Search Results, as opposed to utilizing the Search Words, as a means to generate richer information that can in turn be used to better match against relevant advertisements.

The search engine user issues a search query to a search engine. The search engine analyzes the search query and presents a list of relevant search results. The search engine then analyzes said search results and determines whether additional information is likely relevant to the search engine user's interest or objective in executing their search query. This additional information is fed into matching criteria that provides more relevant advertisements to the search engine user than they might have otherwise obtained had the search engine only used the Search Words to determine which advertisements were relevant.

According to the present invention there is provided a method of choosing advertisements to be shown to a search engine user, comprising the steps of: by an advertiser, providing an advertisement and at least one advertising criterion to a search engine; by a user, performing a search on the search engine using search words, the search providing search results; by the search engine, choosing an advertisement based on the search results and advertising criterion; and showing the chosen advertisement and the search results to the user.

According to the present invention there is provided a method of choosing advertisements to be shown to a search engine user, comprising the steps of: providing at least one advertising criterion; obtaining search results created by a search engine as a result of receiving and analyzing a search query made by the search engine user; analyzing the search results to produce analysis results; and using the analysis results to choose an advertisement matched to the at least one advertising criterion.

### BRIEF DESCRIPTION OF THE DRAWINGS

FIG. 1 is a functional block diagram of a search engine user and an advertiser interfacing with a search engine;

FIG. 2 shows a general flow chart describing the main steps of the method of the present invention;

FIG. 3 is a logic diagram showing the key sequence of steps in one embodiment of this invention as it pertains to the analysis of the Search Results.

### DETAILED DESCRIPTION OF THE INVENTION

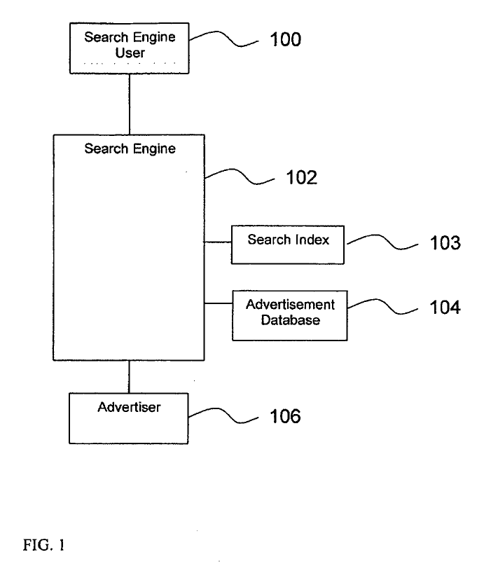

FIG. 1 is a functional block diagram of a User 100 that is interfaced with a search engine 102. Many types of search engines are known, for example Internet Search Engines (ISE) like Google. The search engine utilizes a Search Index 103 and an Advertisement Database 104. An Advertiser 106 is also interfaced with the search engine. User 100 submits Search Words to search engine 102 for the purpose of receiving the Search Results. Advertiser 106 submits advertisements and at least one Advertising Criterion (see below) for the purpose of having advertisements shown to User 100.

The present inventors have developed a method for choosing which advertisements to show to the User, based on the results of the search query he or she made, rather than on the Search Words alone. Since the User enters the Search Words for the purpose of receiving the Search Results, it is reasonable to assume that the Search Results are related to the objective of the User when making the query.

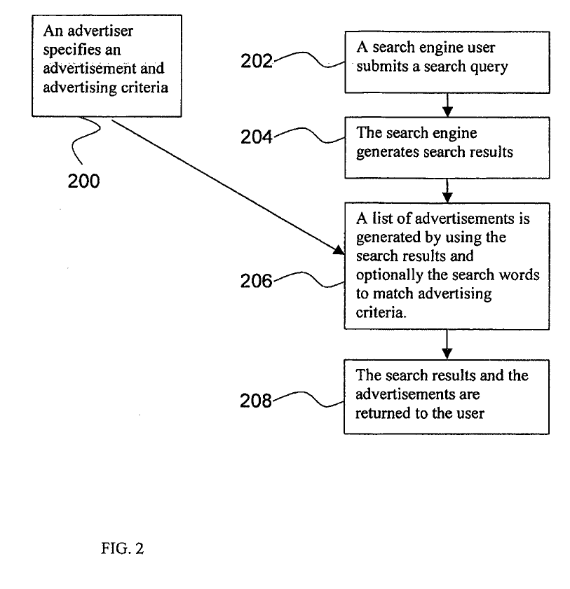

FIG. 2 shows a general flow chart describing the main steps of the method of the present invention:

In step 200, an Advertiser (106) specifies an advertisement and corresponding Advertising Criteria for the advertisement

In step 202, a search engine User (100) submits Search Words to the search engine (102).

In step 204, the search engine uses the search index (103) to generate a set of Search Results for the User's request.

In step 206, the Search Results, optionally combined with the Search Words, are used to query the advertising database (104) to determine which advertisements to show based on the Advertising Criteria from step 200.

In step 208, the Search Results and the Advertisements are shown to the User.

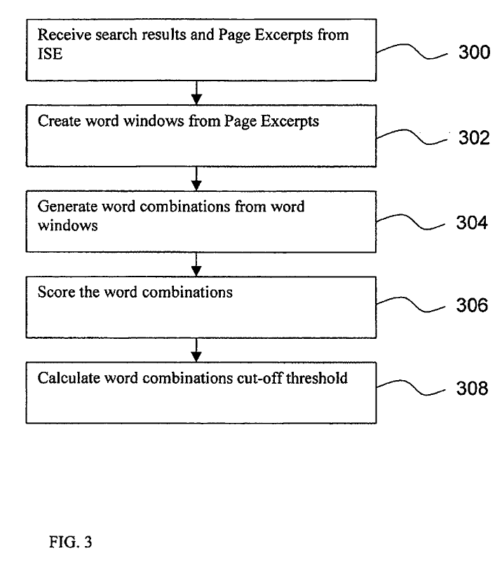

A particularly inventive aspect of the present invention relates to step 206, in which the Search Results are used to query the advertisements database. One possible embodiment of Step 206 is described in more detail in a series of substeps 302-308, shown in FIG. 3. The method includes two major stages: Campaign Setup and Search Results Analysis.

### Campaign Setup

The Campaign Setup is the process by which an advertiser provides one criterion Advertising Criterion”) or more than one criterion (“Advertising Criteria”) for presenting his or her advertisement. The advertiser wishes to have the advertisement shown to the User whenever the Search Results match the Advertising Criterion or Advertising Criteria. One example of an Advertising Criterion is a word match. In this example, the advertiser provides a word or a set of words, and the advertisement appears if the word or set of words are found in the content of the documents referenced by the Search Results (the “Search Result Documents”) or in a corresponding Page Excerpt. A Page Excerpt is the small portion of text shown with the Search Results that highlights the search terms within the document.

It should be noted that all Advertising Criteria may be defined to match not only the Search Results shown to the User, but also Search Results that match the search query but are not shown to the User (e.g. a specific search may have 500 Search Results, but for simplicity the search engine will only show the first 10 to the User).

Another example of an Advertising Criterion is a website address or a Uniform Resource Identifier (URI). For example, an advertiser can enter a website address or URI of a corporate partner and request that the advertisement is shown whenever the website address or URI appears in the User's Search Results.

Yet another example of an Advertising Criterion is a meta-property. For example, an advertiser can enter a company name and request that the advertisement is shown whenever the User's Search Results contains a document whose properties specify that is was authored by said company.

### Search Results Analysis

The Search Results Analysis is the process in which the search engine determines which advertisements to show when the User makes a search query. The first step of Search Results Analysis is receiving the Search Results that were generated as a result of the search query. As mentioned, Page Excerpts, as well as the entire content of the Search Result Documents are considered part of the Search Results for the purpose of analysis. The second step of Search Results Analysis is to check which of the Advertising Criterion or Advertising Criteria previously provided by advertisers are related to the current Search Results. The third step of Search Results Analysis is advertisement prioritization. In some cases, the search engine may find that according to the Advertising Criteria it received for different advertisements, several advertisements should be presented to the User. In this case the search engine may want to omit some of them and/or present them in a certain order. The search engine may take into consideration such things as the type of each matching Advertising Criterion, its strength, and the amount of money the advertiser is willing to pay to have his advertisement used. Once the relevant advertisements are prioritized and filtered, the Search Results, as well as the prioritized list of advertisements are presented to the User.

### Application Example

One embodiment of the invention is implemented as follows and provided as Appendix I to this patent as working code for greater clarity. In this embodiment, we consider an Internet Search Engine (ISE, 102 in FIG. 1), and a User (100 in FIG. 1) connected to the ISE through a web browser running on a personal computer (PC), though any inventor skilled in the art will realize that this invention can be easily adapted to any search engine that is accessible over any computer network or even local to the search engine user's computer.

1. The User executes a query through the web browser running on the PC against the ISE;

2. The ISE analyzes the search query and generates a list of relevant search results (202-204 in FIG. 2) as well as a list of advertisements;

3. The ISE then analyzes the search results (300-308 in FIG. 3);

4. The ISE is queried for more advertisements by using the results from the analysis in step 3;

5. The search results, the original advertisement list from step 2, as well as the advertisements returned by the query in step 4 are presented to the User.

FIG. 3 is a logic diagram showing the key sequence of steps in one embodiment of this invention as it pertains to the analysis of the Search Results. In FIG. 3, each Page Excerpt in the search results, as generated in step 204 of FIG. 2, is extracted in step 300. Because the inventors have determined empirically that the words adjacent to the Search Words provide related information, further to understanding the User's objective or interest, a sliding window for each Page Excerpt is created in step 302. Preferably, the window includes five words, however, more or less than five words can also be used. When creating a window of words, the following words are skipped:
i. Any of the Search Words or a stemmed equivalent.
ii. What is commonly known in the art as stop words (e.g. ‘the’, ‘an’, ‘that’).

For example, if the Search Word is “BR50” and the Page Excerpt is “the BR50 Motorola battery provides your RAZR with three hours of nonstop . . . ”, the corresponding windows would contain:
[Motorola battery provides your RAZR]
[battery provides your RAZR three]
[provides your RAZR three hours]
[your RAZR three hours nonstop]
   In this example, “of”, “the”, “with” are stop words, and the search word “BR50” is also ignored. As mentioned, a window size of 5 words was empirically found to work best.

For each window, all the word combinations are generated in step 304. For greater clarity, the use of the word “combination” is in the statistical sense, where we generate an exhaustive list of all word combinations and orderings. For example, if the window contained [a b c], this embodiment would generate:
[a]
[b]
[c]
[a b]
[b a]
[a c]
[c a]
[b c]
[c b]
[a b c]
[a c b]
[b a c]
[b c a]
[c a b]
[c b a]
   One skilled in the art will see that this combinatorial generation of words may discard potentially valuable information based on the original word order in the Page Excerpt. However, treating the words as order-independent has the advantage of increasing the co-occurrence of significant words and it allows one to treat transposed words as being similar. For example, this technique allows us to recognize that [BR50 Motorola battery] is a concept related to [battery BR50], because one of the combinations of [BR50 Motorola battery] will match one of the combinations of [battery BR50].

Each unique word combination is then scored based upon its number of words and the number of times it appears in the Page Excerpts in step 306 as follows:
i. Each word in the word combination scores one point (“1”) unless it is one of the following:
   a. A “noise” word (see Table 1 for a list of noise words for English). In this case, the word is given a score of 0.2.
   b. Adjectives and adverbs, which receive a score of 0.2.
ii. The scores for the words in each window are summed and then multiplied by the number of times the word combination appeared in all the Page Excerpts and then multiplied by the square root of the number of words in the word combination. The word combinations are then sorted according to their score.

TABLE 1
A list of English Noise Words

| | | | | |
|---|---|---|---|---|
| above | before | either | has | many |
| across | beforehand | eleven | hasnt | may |
| after | behind | else | have | me |
| afterwards | being | elsewhere | he | meanwhile |
| again | below | empty | hence | might |
| against | beside | enough | her | mill |
| all | besides | etc | here | mine |
| almost | between | even | hereafter | more |
| alone | beyond | ever | hereby | moreover |
| along | bill | every | herein | most |
| already | both | everyone | hereupon | mostly |
| also | bottom | everything | hers | move |
| although | but | everywhere | herself | much |
| always | call | except | him | must |
| am | can | features | himself | my |
| among | cannot | few | his | myself |
| amongst | cant | fifteen | however | name |
| amoungst | co | fify | hundred | namely |
| amount | computer | fill | ie | neither |
| another | con | find | if | never |
| any | could | first | inc | nevertheless |
| anyhow | couldnt | five | indeed | next |
| anyone | cry | former | interest | nine |
| anything | de | formerly | into | no |
| anyway | describe | forty | its | nobody |
| anywhere | detail | found | itself | none |
| around | do | four | keep | noone |
| back | done | front | last | nor |
| became | down | full | latter | not |
| because | due | further | latterly | nothing |
| become | during | get | least | now |
| becomes | each | give | less | nowhere |
| becoming | eg | go | ltd | off |
| been | eight | had | made | often |
| once | ten | whereas | | |
| one | than | whereby | | |
| only | their | wherein | | |
| onto | them | whereupon | | |
| other | themselves | wherever | | |
| others | then | whether | | |
| otherwise | thence | which | | |
| our | there | while | | |
| ours | thereafter | whither | | |
| ourselves | thereby | whoever | | |
| out | therefore | whole | | |
| over | therein | whom | | |
| own | thereupon | whose | | |
| part | these | why | | |
| per | they | within | | |
| perhaps | thick | without | | |
| please | thin | would | | |
| put | third | yet | | |
| rather | those | you | | |
| re | though | your | | |
| same | three | yours | | |
| see | through | yourself | | |
| seem | throughout | yourselves | | |
| seemed | thru | | | |
| seeming | thus | | | |
| seems | together | | | |
| serious | too | | | |
| several | top | | | |
| she | toward | | | |
| should | towards | | | |
| show | twelve | | | |
| side | twenty | | | |
| since | two | | | |
| sincere | un | | | |
| six | under | | | |
| sixty | until | | | |
| so | up | | | |
| some | upon | | | |
| somehow | us | | | |
| someone | very | | | |
| something | via | | | |
| sometime | we | | | |
| sometimes | well | | | |
| somewhere | were | | | |
| still | whatever | | | |
| such | whence | | | |
| system | whenever | | | |
| take | whereafter | | | |

A threshold is determined in step 308, and all word combinations whose scores are less than this threshold are eliminated. Preferably, the threshold is given by the formula:

20 log₂(number of Page Excerpts)

Although preferable, this formula is by no means limiting and other thresholds may be used to achieve the objects of the present invention. The remaining (over the threshold) word combinations will then contain words that are not one of the Search Words, but are contextually related to the Search Words (“Context Words”). These Context Words can then be used to re-query Advertisement Database 105. In this embodiment, the Context Words are fed back to the ISE with and without the original Search Words, in effect creating a larger search query. The ISE can then redisplay advertisements in the same fashion as it does today. Although preferable, this step, too, is not limiting and the Context Words may be fed back to the ISE with the original Search Words in various combinations to achieve the objects of the present invention.

Anyone with ordinary skill in the art will realize that this invention can be easily extended to include other forms of Advertising Criterion, which can use additional information from the Search Results, or additional information that can be derived from the Search Results. Several examples, which may be combined in many ways, include:
1. The subject matter or topic of a Search Result. If an online database or algorithm is available and able to classify a Search Result as pertaining or being relevant to a general subject area or topic, the advertiser may wish to have his advertisement presented when a Search Result is classified as belonging to a particular subject area or topic.
2. Specific keywords that allow the advertiser to infer the goal of the User. For example, the appearance of the word ‘Purchase’ in the search results may imply that the User is ready to buy a particular product or service.
3. Linguistic entities (such as currency amounts, dates, times, names, etch).
4. The logical combination of other Advertising Criteria. In this example, the advertiser provides more than one Advertising Criterion, and may define whether all Advertising Criteria should match (AND relation), only one of them should match (OR relation), or a combination thereof.
5. The match frequency of an Advertising Criterion. Since the amount of information displayed in the Search Results may be large, it may be beneficial to require not only that they match an Advertising Criterion, but also that the Advertising Criterion matches a minimal amount of times. For example, the words ‘Plasma’ and ‘TV’ may be required to appear at least 5 times in the Search Results, or in at least 10% of the Search Results.
6. The match location of an Advertising Criterion. The Advertising Criterion may be required to match in the top search results, close to the Search Words or any combination thereof.

7. All Advertising Criteria above may be combined to produce a match score. This match score would be a function of whether different Advertising Criteria matched and the strength of such matches. Naturally, different weights may be given to different Advertising Criteria. In this case, a minimal match score may be provided as the Advertising Criterion.

The method of the present invention has the advantage that its Advertising Criteria are based on significantly more information (compared to just matching words in the User's search query). This allows showing advertisements that more accurately match the User's objective.

Another advantage of the present invention is that it allows an advertiser to use a much smaller list of Advertising Criteria. For example, today a retailer of Plasma TV sets will normally enter all known model codes of Plasma TVs as search words, in case a user searches for one of them (e.g. “W4200HD”, “FWD42PV1” and “TH42PV500”). This is a complicated, time consuming and error-prone process which can easily result in the generation of an outdated keyword list. In the present invention, requiring the words ‘Plasma’ and ‘TV’ to appear in the search results would most likely cover most such cases, since those words are likely to appear alongside the model number in the Page Excerpts (e.g. “The Dell W4200HD 42” High Definition Plasma TV delivers a wide aspect, high-definition resolution giving you life-like picture quality”).

While the invention has been described with respect to a limited number of embodiments, it will be appreciated that many variations, modifications and other applications of the invention may be made.

Appendix 1, attached as an integral part of this specification, presents commented source code written in PHP for a preferred embodiment of the invention

What is claimed is:

1. A method of choosing advertisements to be shown to a search engine user, comprising the steps of:
a. receiving a plurality of advertisements and at least one advertising criterion per advertisement;
b. receiving a search using a search query, the search providing search results;
c. choosing advertisements based on the search results and on at least one advertising criterion; and
d. showing the chosen advertisements and the search results to the user.

2. The method of claim 1, wherein the step of receiving a plurality of advertisements and receiving at least one advertising criterion includes receiving at least one criterion selected from the group consisting of a word match, a word set match, a website address, a uniform resource identifier, a meta-property, a subject matter a subject topic and a combination thereof.

3. The method of claim 1, wherein the step of choosing advertisements using the search results further includes using the search words in addition to the search results.

4. The method of claim 1, wherein the step of receiving a search using a search query includes receiving a search performed on the Internet.

5. The method of claim 1, wherein the search query and/or the provided search results are used to generate a new set of related or expanded search results, and wherein the step of choosing advertisements includes choosing advertisements based on the new set of related or expanded search results.

6. The method of claim 1, wherein the search results include documents with page excerpts generated therefrom and wherein the step of choosing advertisements includes analyzing the page excerpts and/or the documents in their entirety to produce a prioritized list of advertisements.

7. The method of claim 6, wherein the analyzing includes matching at least one advertising criterion with the search results.

8. The method of claim 6, wherein the analyzing includes using a sliding window of words for each page excerpt.

9. The method of claim 8, wherein the using a sliding window of words for each page excerpt includes using a sliding window of five words.

10. The method of claim 8, wherein the using a sliding window of words for each page excerpt includes skipping words selected from the group consisting of search words, stemmed equivalents of search words and stop words.

11. The method of claim 8, wherein the analyzing further includes generating word combinations for each window of words to generate unique word combinations and scoring each unique word combination to produce word combination scores.

12. The method of claim 11, wherein the word combination scores are used for sorting the word combinations according to their scores and eliminating all word combinations that fall below a predetermined threshold, thereby providing word combinations which include words that are not one of the search words, but are contextually related to the search words

13. The method of claim 12, wherein the predetermined threshold is given by the formula 20 log₂(number of page excerpts).

14. A method of choosing advertisements to be shown to a search engine user, comprising the steps of:
a. receiving at least one advertising criterion;
b. obtaining search results created by the search engine as a result of receiving and analyzing a search query;
c. analyzing the search results to produce analysis results; and
d. using the analysis results to choose an advertisement matched to at least one advertising criterion.

15. The method of claim 14, wherein the step of receiving at least one advertising criterion includes receiving at least one criterion selected from the group consisting of a word match, a word set match, a website address, a uniform resource identifier, a meta-property, a subject matter, a subject topic and a combination thereof

16. The method of claim 14, wherein the step of using said analysis results includes prioritizing advertisements based on the analysis results and choosing a highest priority advertisement as the advertisement to be shown to the user.

17. The method of claim 14, wherein the advertising criterion is based on a search result attribute selected from the group consisting of at least one indirectly inferred meta-property, at least one linguistic entity, advertising criteria match frequency, advertising criteria match location, advertising criteria match score and a combination thereof.

18. A method of choosing advertisements to be shown to a search engine user from an existing search engine advertising database, comprising the steps of:
a. receiving a search using a search query, the search providing search results;
b. choosing an advertisement from the database using the search results; and
c. showing the chosen advertisement and the search results to the user.

19. The method of claim 18, wherein the step of choosing an advertisement includes.
a. extracting keywords from the search results; and
b. choosing the advertisement using the keywords.

20. The method of claim 18, further comprising the step of receiving at least one advertising criterion and wherein the step of choosing an advertisement further includes choosing an advertisement using the advertising criterion in addition to the search results.
